(19) United States
(12) Patent Application Publication
(10) Pub. No.: US 2006/0039249 A1
(43) Pub. Date: Feb. 23, 2006

(54) Systems and methods for reading optical-card data

(75) Inventor: Kevin Wilson, Denver, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BSI2000,Inc., Lakewood, CO (US)

(21) Appl. No.: 10/921,596

(22) Filed: Aug. 18, 2004

(51) Int. Cl. G11B 7/00

(52) U.S. Cl. 369/44.11; 369/97

(57) ABSTRACT

Systems and methods are provided for reading data encoded on an optical card as a series of binary pits formed within optical-card tracks separated by an average optical-card track pitch. A translator and a compact-disc laser head are provided. The compact-disc laser head reads data from a compact disc having data encoded as a series of binary pits formed within compact-disc tracks separated by an average compact-disc track pitch. The translator moves the optical card linearly relative to the compact-disc laser head in a direction of motion. The compact-disc laser head is oriented relative to the direction of motion to accommodate a difference between the average optical-card track pitch and the average compact-disc track pitch.

### BACKGROUND OF THE INVENTION

This application relates generally to optical cards. More specifically, this application relates to systems and methods for reading optical-card data.

The development of optical cards has been relatively recent. They are cards that are typically made to be about the size of a standard credit card and which store digitized information in an optical storage area. The information written to the optical storage area is generally written according to a standards protocol that includes, among other things, physical layout restrictions for the optical card. The information encoded in the optical storage area often includes information that identifies a holder of the card, and as such optical cards are expected to become widely used as identification instruments. Indeed, a number of government authorities have already begun to issue optical cards for use as national identity cards, as immigration cards, and the like.

In order to read the information from the optical storage area of an optical card, it has typically been necessary to use an optical reading device specially manufactured to accommodate the physical layout of information on the optical card. This has proved to be relatively costly, and there is accordingly a general need in the art for less costly systems that may be used for reading data from an optical card.

### BRIEF SUMMARY OF THE INVENTION

Embodiments of the invention thus provide systems and methods for reading optical card data that permit the use of a compact-disc laser head to be used despite its configuration for different optical-media characteristics. In one set of embodiments, a system is provided for reading data encoded on an optical card as a series of binary pits formed within a plurality of optical-card tracks separated by an average optical-card track pitch. The system comprises a translator and a compact-disc laser head adapted to read data from a compact disc having data encoded as a series of binary pits formed within a plurality of compact-disc tracks separated by an average compact-disc track pitch. The translator is adapted to move the optical card substantially linearly relative to the compact-disc laser head in a direction of motion. The compact-disc laser head is oriented relative to the direction of motion to accommodate a difference between the average optical-card track pitch and the average compact-disc track pitch.

In some such embodiments, the compact-disc laser head is rotated by an angle Δθ from an angular orientation for reading the binary pits formed within the plurality of compact-disc tracks from a compact disc in motion along the direction of motion. The compact-disc head may be further adapted to control tracking of the compact disc with a pair of tracking beams having a tracking-beam separation. In such instances, Δθ may be approximately a difference between an arctangent of a ratio of the average optical-card track pitch to the tracking-beam separation and an arctangent of the average compact-disc track pitch to the tracking-beam separation. In one embodiment, the tracking-beam separation is approximately 44 μm. In other embodiments, Δθ is between 10° and 15°, is between 12° and 14°, or is approximately 13°.

A variety of different configurations may be provided for the translator. In one embodiment, the translator comprises a channel, a static element, and a moveable element. The static element is disposed within the channel and has a plurality of coils. The moveable element is disposed within the channel and has a plurality of permanent magnets.

In another set of embodiments, a method is provided for reading data encoded on an optical card as a series of binary pits formed within a plurality of optical-card tracks separated by an average optical-card track pitch. The optical card is translated substantially linearly relative to a compact-disc laser head in a direction of motion. The compact-disc laser head is adapted to read data from a compact disc having data encoded as a series of binary pits formed within a plurality of compact-disc tracks separated by an average compact-disc track pitch and oriented relative to the direction of motion to accommodate a difference between the average optical-card track pitch and eth average compact-disc track pitch. The data are read from the translating optical card with the compact-disc laser head.

In some embodiments, he compact-disc laser head may be rotated by an angle Δθ from an angular orientation suitable for reading compact-disc tracks as described above. In one embodiment, the optical card is translated by applying a magnetic force to a moveable element disposed within a channel, with the optical card being disposed over the moveable element. The moveable element may comprise a permanent magnet. In such a case, the magnetic force may be applied by actuating a coil in a vicinity of the moveable element.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIGS. 1A-1C provide schematic illustrations of different forms of optical cards that may be used in embodiments of the invention;

FIGS. 2A and 2B provide an illustration of a structure for a compact-disc laser head in an embodiment of the invention;

FIG. 3 is a flow diagram illustrating a method for determining an orientation of a compact-disc laser head for use in reading optical-card data;

FIG. 4 is a schematic illustration of a structure of track data on an optical card;

FIGS. 5A and 5B illustrate geometries suitably for using a compact-disc laser head in reading compact-disc and optical-card data respectively; and

FIG. 6 provides an illustration of a translation drive for use in systems of the invention in some embodiments.

### DETAILED DESCRIPTION OF THE INVENTION

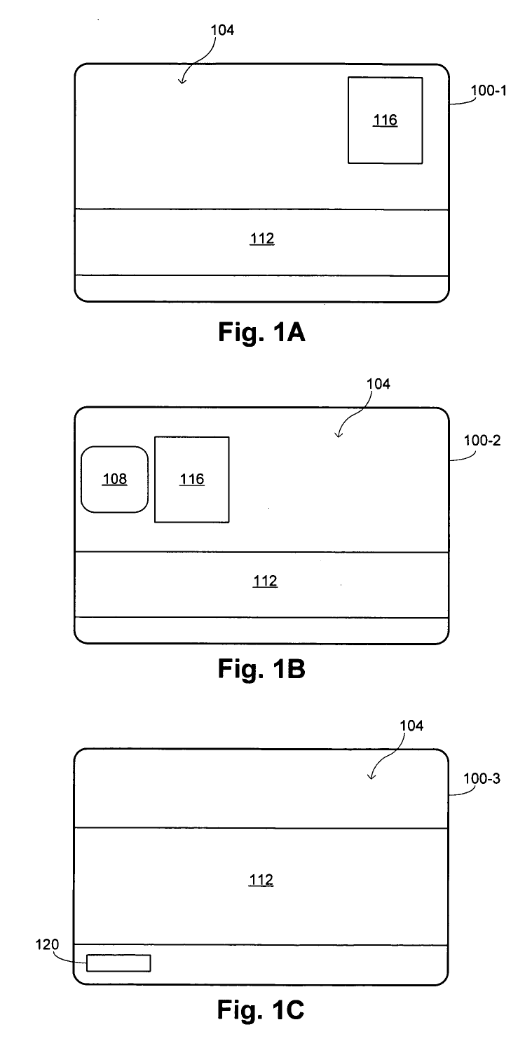

Embodiments of the invention permit a compact-disc laser head to be used in a system for reading optical-card data. The system integrates the compact-disc laser head with an orientation relative to a direction of motion to accommodate differences in physical layouts of information on optical cards and compact discs. These embodiments may function well with a variety of optical-card designs, some of which are illustrated in FIGS. 1A-1C. Such optical cards may be of the specific type described in U.S. Pat. No. 5,979,772, entitled “OPTICAL CARD” by Jiro Takei et al., the entire disclosure of which is incorporated herein by reference for all purposes, but more generally include any card that uses optical storage techniques. Such optical cards are typically capable of storing very large amounts of data in comparison with magnetic-stripe or smart cards. For example, a typical optical card may compactly store up to 4 Mbyte of data, equivalent to about 1500 pages of typewritten information. As such, optical cards hold on the order of 1000 times the amount of information as a typical smart card. Unlike smart cards, optical cards are also impervious to electromagnetic fields, including static electricity, and they are not damaged by normal bending and flexing.

Many optical cards use a technology similar to the one used for compact discs (“CDs”) or for CD ROMs. For example, a panel of gold-colored laser-sensitive material may be laminated on the card and used to store the information. The material comprises several layers that react when a laser light is directed at them. The laser etches a small pit, about 2 μm in diameter, in the material; the pit can be sensed by a low-power laser during a read cycle. The presence or absence of the pit defines a binary state that is used to encode data. In some embodiments, the data can be encoded in a linear x-y format described in detail in the ISO/IEC 11693 and 11694 standards, the entire contents of which are incorporated herein by reference for all purposes.

FIG. 1A provides a diagram that illustrates a structure for an optical card in one embodiment. The card 100-1 includes a cardholder photograph 116, an optical storage area 112, and a printed area 104 on one side of the card. The other side of the card could include other features, such as a bar code(s) or other optically recognizable code, a signature block, a magnetic stripe, counterfeiting safeguards, and the like. The printed area 104 could include any type of information, such as information identifying the cardholder so that, in combination with the photograph 116, it acts as a useful aid in authenticating a cardholder's identity. The printed area 104 could also include information identifying the issuer of the card, and the like. The optical storage area 112 holds digitized information, and may comprise a plurality of individual sections that may be designated individually by an addressing system.

Another embodiment of an optical banking card 100-2 is illustrated in FIG. 1B. This embodiment adds electronics 108 to the optical card 100-2 to provide smart-card capabilities. The electronics 108 may be interfaced with contacts on the surface of the card 100-2. The electronics could include a microprocessor, nonvolatile memory, volatile memory, a cryptographic processor, a random-number generator, and/or any other electronic circuits. Unlike the optical storage area 112, information stored in the electronics 108 is not discernible without destroying the card 100-2. Electronic security measures could be used to protect reading information stored in the electronics 108.

A further embodiment of an optical banking card 100-3 is shown in FIG. 1C. To illustrate that different embodiments may accommodate different sizes of optical storage areas, this embodiment uses a larger optical storage area 112 than the embodiments of FIG. 1A or 1B. In addition, a radio-frequency identification (“RFID”) tag 120 that can be read by proximity readers may be included.

An example of differences in the layouts of information on optical cards and on compact discs is illustrated with Table 1, which compares a number of properties of an exemplary optical card with a compact disc.

TABLE 1
Summary of formats for optical cards and compact discs

| | | |
|---|---|---|
| Quantity | Optical Card | Compact Disc |

| Track Pitch (μm) | 12.0 | | 1.6 | |
|---|---|---|---|---|
| Track Guide Width (μm) | 2.2 | | 0.5 | |
| Pit Distance (μm) | 5 | | 0.83 | |
| Pit Diameter (μm) | 2.2 | | ˜0.5 | |
| Laser Wavelength (μm) | 760-850 | | 780 | |
| Area/bit (μm²) | 60 | | 1.3 | |
| Area (mm²) | 2070 | | 8796 | |
| Head Velocity | 100 | mm/s | 1.2-1.4 | m/s |
| Beam Diameter (μm) | 2.5 | | | |
| Recording Method | MFM-RZ | | MFM | |
| Bit Frequency | 10-20 | kHz | 4.3 | MHz |

In the table, the pit diameter for the compact disc has been estimated based on other physical parameters. Also, the head velocity has been determined from an angular speed of a compact disc of 200-600 rpm. The designation of the recording method as “MFM” for the compact disc refers to modified frequency modulation, which is well known in the art as a refinement of frequency-modulation encoding to reduce the number of flux reversals by inserting a clock reversal only between consecutive zeros. The designation “MFM-RZ” refers to a further modification of MFM encoding with a return to zero so that a flux reversal is used to indicate a “1” bit and the lack of a flux reversal is used to indicate a “0” bit.

The table notes that both certain optical cards and compact discs may be read with a laser wavelength of about 0.78 μm. One difference between the two formats is that the track guides for an optical card may be about 7.5 times larger than those for a compact disc; the pit diameter for the compact disc is also generally smaller than for an optical card because it needs to fit within the smaller 1.6-μm track. These differences preclude widely available compact-disc laser heads from simply being used to read data from optical cards. The inventor has recognized, however, that a modification in physical orientation of a compact-disc laser drive relative to a direction of motion for an optical card permits a compact-disc laser head to be used in a system for reading data from optical cards. In some embodiments, the compact-disc laser head is rotated by an additional angle relative to the direction of motion.

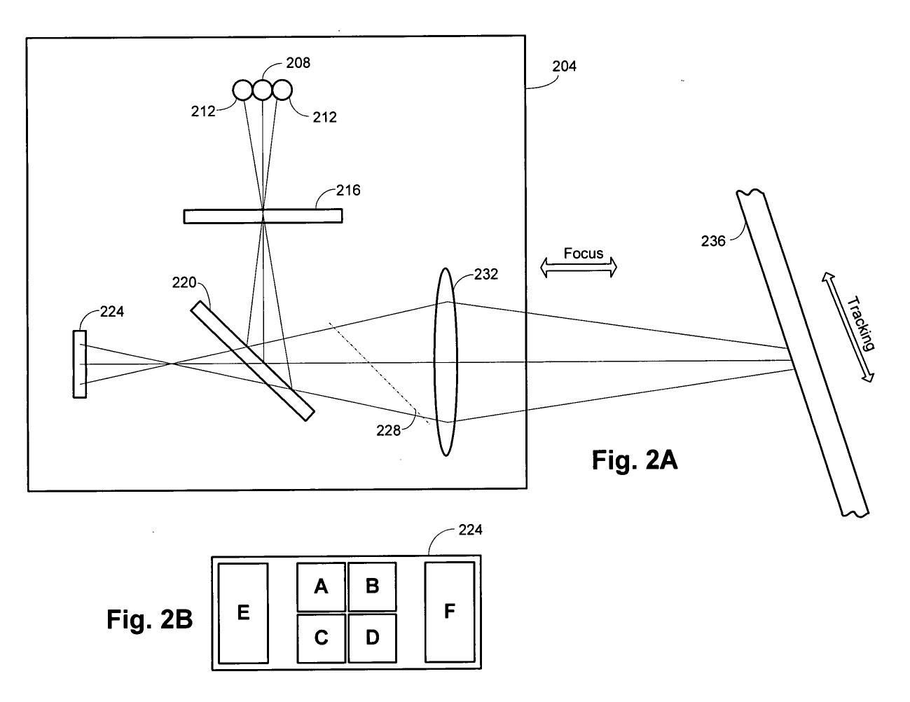

A schematic illustration of the structure of a typical compact-disc laser head is provided in FIG. 2A. The laser head 204 comprises a source of substantially monochromatic illumination, such as a diode laser 208. Light from the illumination source 208 is directed to a diffraction grating 216, which splits the light into a main beam and two secondary beams according to different diffraction orders. In particular, the angles α of the beams are given by the diffraction grating equation
d sin α=mλ,
where d is the grating period and m is an integral order of interference for light having a wavelength λ. The zero-order beam (m=0) thus corresponds to the main beam for reading data and has no change in angle of propagation. The first-order beams (m=±1) correspond to the secondary beams and act as tracking beams deflected by angles ±α. Virtual images of the illumination source corresponding to these secondary beams are denoted by numerals 212. The beams pass through a beamsplitter 220 and are focused by a lens 232 onto the surface of a medium 236, intended to be the surface of a compact disc in the conventional operation of a compact-disc laser head 204. Light reflected from the medium surface 236 is refocused by the lens 232 onto a detector array 224, such as a photodiode array. The presence or absence of pits on the surface medium at particular locations is determined by whether light is detected at the detector array 224.

For the simplified illustration shown, the medium moves in a direction substantially out of the page. A tracking motor (not shown) moves the head assembly 204 up and down and a focusing motor (not shown) moves the head assembly 204 in left/right directions. Double-headed arrows are labeled on the drawing to show the directions of motions provided by the respective motors. Also, for purposes of illustration, the optics shown in FIG. 2A have been somewhat simplified so that they may conveniently be illustrated in two dimensions. In many instances, actual compact-disc laser heads direct the beams in three dimensions but use the same principles illustrated in FIG. 2A. For instance, some compact-disc laser heads include a folding mirror at location 228 to point the beams downwards by 90°, causing the diffraction grating 216 and detector array 224 to be tipped about 45° out of the plane of the page. Still other modifications may be present in various compact-disc laser head designs, such as by using a prism or grism as a diffractive element in place of the grating 216 and/or by using curved mirrors in place of the lens 232.

A schematic illustration is provided for a typical layout of the detector array 224 in FIG. 2B. In this example, the detector array 224 comprises a plurality of photodiodes that detect light, with the photodiodes being labeled “A,” “B,” “C,” “D,” “E,” and “F.” The data are extracted from the central photodiodes as a sum of intensities on the central photodiodes, A+B+C+D. A focusing error may be determined by a difference in intensity for crossed configurations of the photodiodes, i.e. from (A+D)−(B+C). In similar fashion, a tracking error may be determined from a difference in intensity for the side photodiodes, i.e. from E−F. While the layout shown in FIG. 2B is common in compact-disc laser heads, it is possible in some instances for alternative arrangements to be used without deviating from the scope of the invention described herein.

The physical parameters for compact-disc laser heads are designed to accommodate the physical layout of data on compact discs. Such parameters include the optical properties of the optical components, such as focal length of the lens, the grating period of the diffraction grating, and the like, as well as the relative positioning of elements, such as distances between the light source and grating, distances between the grating and beam splitter, distances between the beam splitter and the lens, etc. These parameters are carefully determined by manufacturers of compact-disc laser heads to meet stringent performance criteria in reading optically encoded information at the level of microns. The inventor has realized, however, that even with the resulting structure of a compact-disc laser head being specifically tailored to reading compact discs, it may be used in a system for reading optical data from optical cards. This may be accomplished without modification to the internal structure of the compact-disc laser head by orienting the laser head relative to a direction of motion of the optical card with respect to the laser head to accommodate a difference between an average optical-card track pitch and an average compact-disc track pitch for which the laser head is designed.

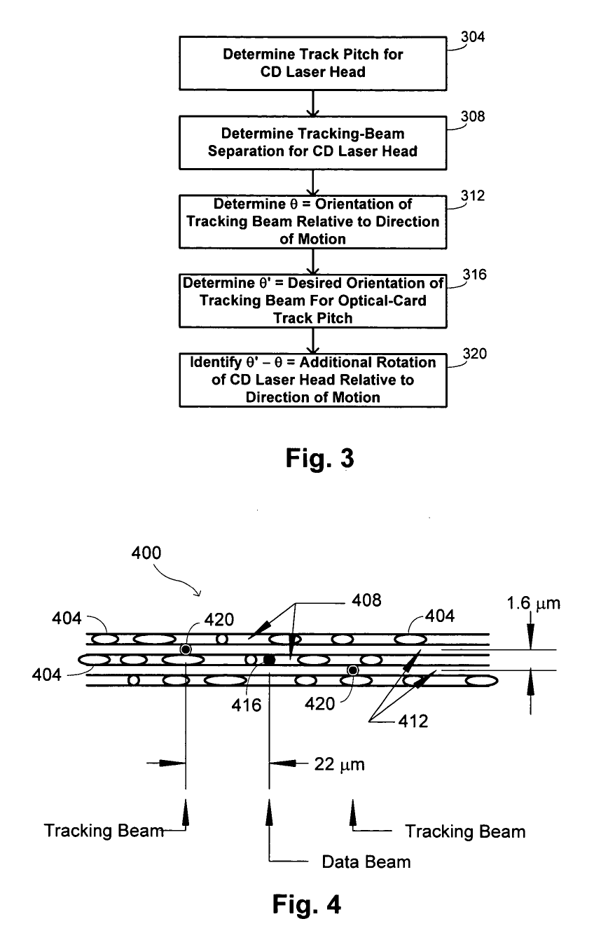

An overview of how the relative orientation of a given compact-disc laser head may be determined is provided with the flow diagram of FIG. 3. Characteristics that define how the physical data layout for which the compact-disc laser head was designed are determined at blocks 304 and 308. In particular, the track pitch and tracking beam separation for which the compact-disc laser head was designed are determined. From this information, an orientation θ is determined at block 312 for the tracking beam provided by the laser head relative to the direction of motion of the compact disc with respect to the laser head. For example, for a determined compact-disc track pitch PCD and determined tracking-beam separation s, the desired orientation may be

$$θ = {tan}^{- 1} \frac{{p}_{CD}}{s} .$$

It should be appreciated that references herein to relative motion of an optical medium, such as a compact disc or a optical card, with respect to the laser head may be provided by movement of the optical medium, by movement of the laser, or by movement of both in different embodiments. All such possibilities are intended to be included within the scope of references to motion of an optical medium relative to a laser head.

At block 316 of FIG. 3, the desired orientation θ′ of the tracking beam to accommodate the track pitch of an optical card is determined. For example, to accommodate an optical-card track pitch pₒ, the desired orientation may be

$${θ}^{′} = {tan}^{- 1} \frac{{p}_{o}}{s} ,$$

where the same tracking-beam separation has been used. It was not initially apparent that the tracking-beam separations for the two instances would be sufficiently similar that a determination of θ′ could be made in this way, i.e. that a suitable orientation to accommodate the compact-disc track pitch would allow the tracking beam arrangement of the compact-disc laser head to function correctly. The explicit example described below illustrates an analysis undertaken by the inventor to confirm that the tracking-beam arrangement would, in fact, function correctly with the desired orientation. As indicated at block 320, the difference in angles, Δθ=θ′−θ, then defines an additional rotation of the compact-disc laser head to be used in a system for reading optical cards.

### EXAMPLE

As noted, when considering the possibility of using a compact-disc laser head in a system for reading data from optical cards, it was not evident that tracking-beam separations for the configurations would be compatible. It is, for example, not apparent that this is true from the information regarding formatting for optical cards and compact discs summarized in Table 1. The inventor accordingly set out to analyze an existing compact-disc laser head, to determine how to orient it for use in an optical-card reading system, and to ascertain whether the tracking-beam configuration would function adequately when reading optical cards. The inventor accordingly disassembled a KSS360A laser head unit originally manufactured by Sony.

Determined measurements of the components of the KSS360A unit are summarized in Tables 2-4. Table 2 sets forth properties of the diffraction grating as determined using a 680-nm laser pointer.

TABLE 2
Properties of Diffraction Grating in a KSS360A Laser Head Unit

| Quantity | Value |
|---|---|
| sin α | 0.022 |
| grating period d | 30.9 μm |

The value of sin α determined at a wavelength λ=680 nm corresponds to a value of sin α=0.025 for the laser-head wavelength λ=780 nm.

Table 3 sets forth center-to-center distances for the arrangement of photodiodes shown in FIG. 2B.

TABLE 3
Photodiode Dimensions in a KSS360A Laser Head Unit

| | Center-to-Center |
|---|---|
| Detectors | Distance (μm) |
| A-B | 57 |
| E-F | 310 |

Table 4 lists the values of a number of physical parameters determined by measurement of the disassembled KSS360A laser-head unit, and additionally provides a number of calculated values determined from those measurements. The measured distances and calculated values are provided in the right-hand portion of the table, while the left-hand portion symbolically defines the components used in making the measurements.

TABLE 4
Physical Parameters of a KSS360A Laser Head Unit
Symbol Definition

| Component | Symbol |
|---|---|
| Laser | Z |
| Virtual Laser Image | V |
| Grating | G |
| Beam Splitter | S |
| Folding Mirror | F |
| Lens | L |
| Media Data | M |
| Detector | T |
| Detector, Data Image | T_{d} |
| Detector, Track Guide Image | T_{g} |
| Media Track Guide | g |
| Angle at Grating, from Normal | φ |

Parameter Determination
Measured Parameters

| Parameter | Distance (mm) |
|---|---|
| Laser - Grating Z-G | 3.8 |
| Grating - Lens G-L | 17.4 |
| Lens - Media L-M | 5 |
| Lens - Detector L-T | 25.6 |
| Grating - Splitter G-S | 1.65 |
| Splitter - Lens S-L | 15.8 |
| Splitter - Detector S-T | 9.8 |
| Focus Motion of Lens | 3.0 |
| Tracking Motion of Lens | 2.5 |
| T_{d} - T_{g} | 0.138 |

Values Calculated from Measured Parameters

| Parameter | Value |
|---|---|
| sin α | 0.025 |
| Virtual Laser - Laser V-Z | 0.095 |
| Media Data - Media Track | 0.022 |
| Guide M-g | |
| T_{d} - T_{g} | 0.114 |

The ability of the tracking-beam configuration to accommodate an optical-card layout is suggested by the fact that the difference in the track-data distance T_{d}−T_{g} as measured and calculated is well within the focusing distance of the lens. The lens can move about ±1.25 mm, which is equal to about 0.38 times its focal length, while the measured value of T_{d}−T_{g} is 138 μm and the calculated value of T_{d}−T_{g} is 114 μm. The tracking within the compact-disc laser head is performed generally by matching the signals received at the E and F detectors shown in FIG. 2B. To illustrate how the exemplary laser-head unit may be used in a system for reading optical cards, the geometry of an optical-medium surface is shown in greater detail in FIG. 4. The medium surface 400 includes a plurality of tracks 408 that are separated by track guides 412. The data stored on the medium are encoded with the pits 404 etched within the tracks 408.

When a data beam 416 (corresponding to the primary beam with m=0 above) is focused on a track 408, a pair of tracking beams 420 are focused on the surrounding track guides 412. The longitudinal separation of the track beams 420 along the length of the tracks 408 or track guides 412 is twice the media data—media track guide M-G value, and so is about 2×0.022 mm=44 μm for the KSS360A. The transverse separation of the track beams 420 is equal to the track pitch of about 1.6 μm. The effect of rotating the laser head, which is equivalent to rotating the grating within the head assembly, is to change the effective track pitch and track-beam separations.

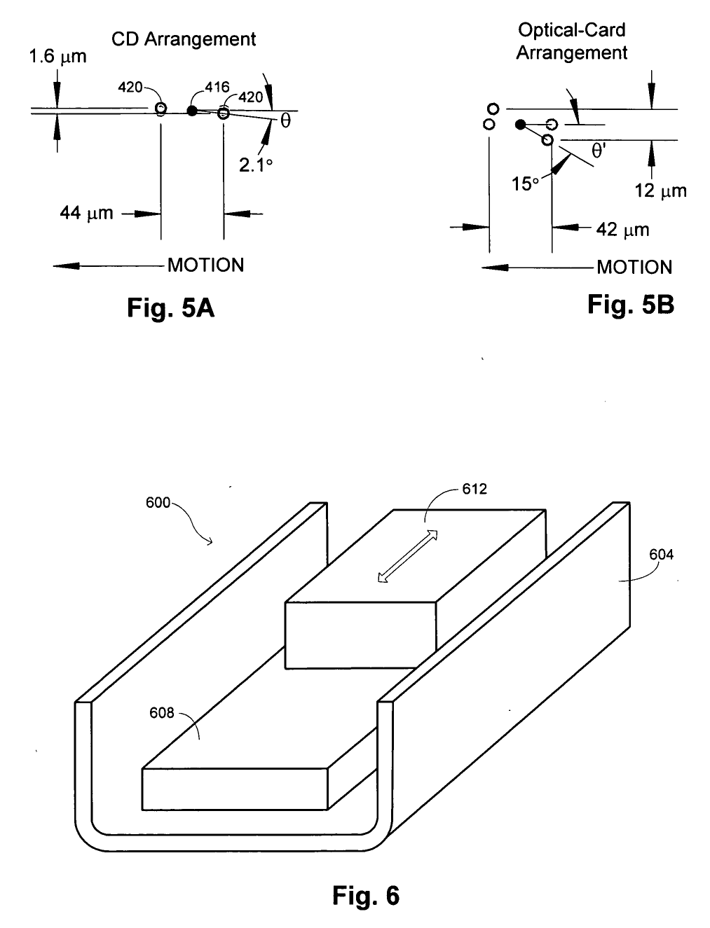

FIGS. 5A and 5B illustrate how the additional rotation may be determined and also demonstrate that the change in track pitch may be accommodated without a substantial change in tracking-beam separation. FIG. 5A illustrates the geometry when the compact-disc laser head is used in its intended configuration. Denoting the transverse track pitch as p_{CD} (=1.6 μm) and the longitudinal separation of the track beams as s_{CD} (=44 μm), the angle of inclination of the laser head with respect to a direction of motion of the compact disc is

$$θ = {tan}^{- 1} \frac{{p}_{CD}}{{s}_{CD}} = {tan}^{- 1} \frac{1.6}{44} ≃ 2.1 ° .$$

Similarly denoting comparable quantities for a configuration for use with an optical card having a transverse track pitch pₒ, the angle of inclination of the laser head with respect to a direction of motion of the optical card is

$${θ}^{′} = {sin}^{- 1} \frac{{p}_{o}}{\sqrt{{s}_{CD}^{2} + {p}_{CD}^{2}}} = {sin}^{- 1} \frac{12}{\sqrt{{44}^{2} + {1.6}^{2}}} ≃ 15.8 ° ,$$

and the desired track-beam separation is
sₒ=\sqrt{s_{CD}²+p_{CD}²−pₒ²}=\sqrt{44²+1.6²−12²} μm≅42.4 μm.
Notably, the difference in track-beam separations is less than 4%, allowing the slightly larger track-beam separation provided by the compact-disc laser head to be used in the optical-card configuration without adversely affecting the tracking control. In particular, with the compact-disc laser head rotated by an angle Δθ=θ′−θ≅13.7° to provide the 15.8° inclination, the tracking beam separation of provided by the physical layout of the compact-disc laser head s_{CD}≡s(≅sₒ)=44 μm provides a track pitch of
pₒ=s tan θ′≅12.4 μm,
very close to the actual track pitch.

Thus, rotation of the entire compact-disc laser head by an angle Δθ between about 10° and 15° relative to the direction of motion of an optical card compared with its orientation for reading a compact disc allows the optical card to be read. More particularly, the rotation Δθ may be between 12° and 14°, or may be approximately 13° in different embodiments. The tracking control of the compact-disc laser head still functions correctly in such embodiments while reading the optical card. This may be understood by noting that the tracking control effectively rotates the lens of the laser head about a centralized axis, and further rotation of the entire system about that access does not substantially affect operation of the control system. While the KSS360A laser head has been described in the above example, that description is intended to be purely exemplary and not limiting.

There are a number of different way that the motion of the optical card relative to the compact-disc laser head may be achieved in different embodiments. One example is provided with FIG. 6, which illustrates a translator 600 in the form of a linear motor that may be incorporated into the system for reading optical-card data. A static element 608 and a moveable element 612 are provided within a U-shaped channel 604. The channel 604 may be mounted on any suitable surface within the system. A top surface of the static element 608 may include one or more coils and the moveable element 612 may include one or more permanent magnets. Actuation of the coil(s) in the static element 608 generates a magnetic field that produces a magnetic force through the permanent magnets of the moveable element 612, causing the moveable element to move. By having the optical card positioned on the moveable element, the desired motion to read the optical card with the described system may be provided. Examples of other translators that operate as linear motors and may be used in alternative embodiments are provided in, for example, U.S. Pat. Nos. 3,594,622; 3,699,365; 3,706,922; 3,770,995; 3,824,414; 3,884,154; and 4,595,870, each of which is incorporated herein by reference for all purposes.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A system for reading data encoded on an optical card as a series of binary pits formed within a plurality of optical-card tracks separated by an average optical-card track pitch, the system comprising:
a translator; and
a compact-disc laser head adapted to read data from a compact disc having data encoded as a series of binary pits formed within a plurality of compact-disc tracks separated by an average compact-disc track pitch,
wherein:
the translator is adapted to move the optical card substantially linearly relative to the compact-disc laser head in a direction of motion; and
the compact-disc laser head is oriented relative to the direction of motion to accommodate a difference between the average optical-card track pitch and the average compact-disc track pitch.

2. The system recited in claim 1 wherein the compact-disc laser head is rotated by an angle Δθ from an angular orientation for reading the binary pits formed within the plurality of compact-disc tracks from a compact disc in motion along the direction of motion.

3. The system recited in claim 2 wherein:
the compact-disc head is further adapted to control tracking of the compact disc with a pair of tracking beams having a tracking-beam separation; and
Δθ is approximately a difference between an arctangent of a ratio of the average optical-card track pitch to the tracking-beam separation and an arctangent of the average compact-disc track pitch to the tracking-beam separation.

4. The system recited in claim 3 wherein the tracking-beam separation is approximately 44 μm.

5. The system recited in claim 2 wherein Δθ is between 10° and 15°.

6. The system recited in claim 5 wherein Δθ is between 12° and 14°.

7. The system recited in claim 5 wherein Δθ is approximately 13°.

8. The system recited in claim 1 wherein the translator comprises:
a channel;
a static element disposed within the channel and having a plurality of coils; and
a moveable element disposed within the channel and having a plurality of permanent magnets.

9. A method for reading data encoded on an optical card as a series of binary pits formed within a plurality of optical-card tracks separated by an average optical-card track pitch, the method comprising:
translating the optical card substantially linearly relative to a compact-disc laser head in a direction of motion, the compact-disc laser head being adapted to read data from a compact disc having data encoded as a series of binary pits formed within a plurality of compact-disc tracks separated by an average compact-disc track pitch and oriented relative to the direction of motion to accommodate a difference between the average optical-card track pitch and the average compact-disc track pitch; and
reading the data from the translating optical card with the compact-disc laser head.

10. The method recited in claim 9 wherein the compact-disc laser head is rotated by an angle Δθ from an angular orientation for reading the binary pits formed within the plurality of compact-disc tracks from a compact disc in motion along the direction of motion.

11. The method recited in claim 10 further comprising tracking the optical card with a pair of tracking beams provided by the compact-disc head and having a tracking-beam separation for tracking the compact disc, wherein Δθ is approximately a difference between an arctangent of a ratio of the average optical-card track pitch to the tracking-beam separation and an arctangent of the average compact-disc track pitch to the tracking-beam separation.

12. The method recited in claim 10 wherein Δθ is between 10° and 15°.

13. The method recited in claim 10 wherein Δθ is approximately 13°.

14. The method recited in claim 9 wherein translating the optical card comprises applying a magnetic force to a moveable element disposed within a channel, the optical card being disposed over the moveable element.

15. The method recited in claim 14 wherein:
the moveable element comprises a permanent magnet; and
applying the magnetic force comprises actuating a coil in a vicinity of the moveable element.

16. A system for reading data encoded on an optical card as a series of binary pits formed within a plurality of optical-card tracks separated by an average optical-card track pitch, the system comprising:
means for reading data from a compact disc having data encoded as a series of binary pits formed within a plurality of compact-disc tracks separated by an average compact-disc track pitch; and
means for translating the optical card along a direction of motion oriented relative to the means for reading to accommodate a difference between the average optical-card track pitch and the average compact-disc track pitch.

17. The system recited in claim 16 wherein the direction of motion is rotated by an angle Δθ from a compact-disc direction of motion suitable for reading data with the means for reading from the compact disc.

18. The system recited in claim 17 wherein:
the means for reading comprising means for tracking the compact disc with a pair of tracking beams having a tracking-beam separation; and
Δθ is approximately a difference between an arctangent of a ratio of the average optical-card track pitch to the tracking-beam separation and an arctangent of the average compact-disc track pitch to the tracking-beam separation.

19. The system recited in claim 16 wherein the means for translating comprises:
a channel;
a static means disposed within the channel and having a coil; and
a moveable means disposed within the channel and having a permanent magnet.
